(19) United States
(12) Patent Application Publication
(10) Pub. No.: US 2017/0004770 A1
(43) Pub. Date: Jan. 5, 2017

(54) THREE-DIMENSIONAL DISPLAY SYSTEM

(71) Applicant: Shenzhen China Star Optoelectronics Technology Co., Ltd., Shenzhen (CN)

(72) Inventor: Yufeng JIN, Shenzhen (CN)

(21) Appl. No.: 14/774,134

(22) PCT Filed: Jul. 29, 2015
(86) PCT No.: PCT/CN2015/085434

§ 371 Date: Sep. 10, 2015

(30) Foreign Application Priority Data
Jul. 2, 2015 (CN) 201510381424.1

(51) Int. Cl. G09G 3/3258; H04N 13/04; G09G 3/00

(52) U.S. Cl. CPC G09G 3/3258; G09G 3/003; H04N 13/044; G09G 2320/0209; G09G 2310/0289; G09G 2310/0243; G09G 2300/0809; G09G 2330/021

(57) ABSTRACT

A three dimensional (3D) display system includes 3D display panel and a 3D shutter glasses. The 3D display panel includes pixel units, control circuits, a power supply, data lines and scan lines. The control circuit is used for controlling a supply voltage of the supply voltage terminal, based on a control signal, to determine whether the pixel unit display left or right eye images.

### BACKGROUND OF THE INVENTION

1. Field of the Invention

The present invention relates to a display technology field, more particularly to a three-dimensional (3D) display system.

2. Description of the Prior Art

Organic Light-Emitting Diode (OLED) is self-illuminating and works without a backlight. It is thin and reacts fast, while having a high contrast ratio and a wider viewing angle. Thus, OLED has been broadly used by display manufacturers.

A 3D system comprises an OLED display panel and a pair of shutter glasses. To avoid crosstalk between the Nth frame and the N+1th frame, the OLED panel displays at a frequency of 240 HZ.

As shown in FIG. 1, a signal 11 applied on an OLED panel comprises left eye image data 101, right eye image data 103, and black image data 102 therebetween. The 3D glasses are enabled by an enabling signal STV. A left lens 12 enables when the OLED panel shows the left eye image data 101. A right lens 13 enables when the OLED panel shows the right eye image data 103. However, due to the fact that a certain time is needed to fully enable or disable lenses, the moment when the right lens 13 is just enabled, the left lens 12 is not fully disabled. As a result, the right eye image data 103 enters the left lens 12, as shown in region A. Thus crosstalk emerges, affecting viewing quality.

Therefore, it is necessary to provide a new 3D display system to solve the crosstalk issue in conventional 3D display technology.

### SUMMARY OF THE INVENTION

The present invention provides a 3D display system that avoids crosstalk phenomenon, in order to solve the common issue of crosstalk in conventional 3D display technology.

According to the present invention, a three dimensional (3D) display system comprises an organic light emitting diode (OLED) display panel and a 3D shutter glasses. The OLED display panel comprises a plurality of pixel units, a control circuit, a power supply, a plurality of data lines for transmitting data signals, and a plurality of scan lines for transmitting scan signals. The plurality of pixel units surrounded by the plurality of data lines and the plurality of scan lines, are used for display images according to the data signals and the scan signals. Each pixel unit comprises a data signal input terminal connecting one of the plurality of data lines, a scan signal input terminal connecting one of the plurality of scan lines, a supply voltage terminal connecting the power supply, and an organic light emitting diode (OLED) for pixel display. Each pixel unit further comprises a third transistor and a fourth transistor, the third transistor comprises an input terminal coupled with a corresponding data line via the data signal input terminal, a control terminal coupled with a corresponding scan line via the scan signal input terminal, and an output terminal coupled with a control terminal of the fourth transistor, and the fourth transistor comprises an input terminal coupled with the supply voltage terminal, and an output terminal coupled with the OLED. The control circuit is used for controlling a supply voltage of the supply voltage terminal, based on a control signal, to determine whether the pixel unit display left or right eye images. The control circuit further comprises a first transistor and a second transistor, the first transistor comprises a control terminal coupled with the control signal, an input terminal coupled with a control terminal of the second transistor, and an output terminal grounded, the second transistor comprises an input terminal coupled with the power supply, and an output terminal coupled with the supply voltage terminal of a corresponding pixel unit. The 3D shutter glasses comprise a left eye shutter and a right eye shutter. When the left eye shutter is fully enabled, the pixel units display left eye image, and when the right eye shutter is fully enabled, the pixel units display right eye image.

In one aspect of the present invention, the first transistor is an NPN type transistor, and the second transistor is a PMOS transistor.

In another aspect of the present invention, when the left eye shutter is fully enabled and the control signal is set at a high voltage level, supply voltage from the power supply is fed to the supply voltage terminal via the second transistor, so the pixel unit display the left eye image; and when the right eye shutter is fully enabled and the control signal is set at a low voltage level, supply voltage from the power supply is fed to the supply voltage terminal via the second transistor, so the pixel unit display the right eye image; and when either the left eye shutter or the right eye shutter is not fully enabled, the control signal is set at a low voltage, and the supply voltage terminal disconnect with the power supply.

In another aspect of the present invention, the left eye image further comprises a left eye data image for display and a left eye black image for preventing crosstalk, and the right eye image further comprises a right eye data image for display and a right eye black image for preventing crosstalk.

In another aspect of the present invention, the left eye black image is displayed subsequent to the left eye data image and prior to the right eye data image, and the right eye black image is displayed subsequent to the right eye data image and prior to the left eye data image.

In another aspect of the present invention, a first black interval is inserted between the left eye image and the right eye image, and the control signal is set at the low voltage level to disconnect the power supply and the supply voltage terminal during the first blank interval.

In still another aspect of the present invention, a second black interval is inserted between the left eye data image and the left eye black and is inserted between the right eye data image and the left eye black, and the control signal is set at the high voltage level to connect the power supply and the supply voltage terminal via the second transistor during the second blank interval.

In yet another aspect of the present invention, the data signals are triggered by an enabling signal.

According to the present invention, a three dimensional (3D) display system comprises an organic light emitting diode (OLED) display panel and a 3D shutter glasses. The OLED display panel comprises a plurality of pixel units, a control circuit, a power supply, a plurality of data lines for transmitting data signals, and a plurality of scan lines for transmitting scan signals. The plurality of pixel units surrounded by the plurality of data lines and the plurality of scan lines, are used for display images according to the data signals and the scan signals. Each pixel unit comprises a data signal input terminal connecting one of the plurality of data lines, a scan signal input terminal connecting one of the plurality of scan lines, a supply voltage terminal connecting the power supply, and an organic light emitting diode (OLED) for pixel display. The control circuit is used for controlling a supply voltage of the supply voltage terminal, based on a control signal, to determine whether the pixel unit display left or right eye images. The 3D shutter glasses comprise a left eye shutter and a right eye shutter. When the left eye shutter is fully enabled, the pixel units display left eye image, and when the right eye shutter is fully enabled, the pixel units display right eye image.

In one aspect of the present invention, the control circuit further comprises a first transistor and a second transistor, the first transistor comprises a control terminal coupled with the control signal, an input terminal coupled with a control terminal of the second transistor, and an output terminal grounded, the second transistor comprises an input terminal coupled with the power supply, and an output terminal coupled with the supply voltage terminal of a corresponding pixel unit.

In another aspect of the present invention, the first transistor is an NPN type transistor, and the second transistor is a PMOS transistor.

In another aspect of the present invention, when the left eye shutter is fully enabled and the control signal 34 is set at a high voltage level, supply voltage from the power supply is fed to the supply voltage terminal via the second transistor, so the pixel unit display the left eye image; when the right eye shutter is fully enabled and the control signal is set at a low voltage level, supply voltage from the power supply is fed to the supply voltage terminal via the second transistor, so the pixel unit display the right eye image; and when either the left eye shutter or the right eye shutter is not fully enabled, the control signal is set at a low voltage, and the supply voltage terminal disconnect with the power supply.

In another aspect of the present invention, the left eye image further comprises a left eye data image for display and a left eye black image for preventing crosstalk, and the right eye image further comprises a right eye data image for display and a right eye black image for preventing crosstalk.

In another aspect of the present invention, the left eye black image is displayed subsequent to the left eye data image and prior to the right eye data image, and the right eye black image is displayed subsequent to the right eye data image and prior to the left eye data image.

In another aspect of the present invention, a first black interval is inserted between the left eye image and the right eye image, and the control signal is set at the low voltage level to disconnect the power supply and the supply voltage terminal during the first blank interval.

In another aspect of the present invention, a second black interval is inserted between the left eye data image and the left eye black and is inserted between the right eye data image and the left eye black, and the control signal is set at the high voltage level to connect the power supply and the supply voltage terminal via the second transistor during the second blank interval.

In still another aspect of the present invention, each pixel unit further comprises a third transistor and a fourth transistor, the third transistor comprises an input terminal coupled with a corresponding data line via the data signal input terminal, a control terminal coupled with a corresponding scan line via the scan signal input terminal, and an output terminal coupled with a control terminal of the fourth transistor, and the fourth transistor comprises an input terminal coupled with the supply voltage terminal, and an output terminal coupled with the OLED.

In yet another aspect of the present invention, the data signals are triggered by an enabling signal.

In contrast to prior art, the present invention avoids crosstalk phenomenon by controlling supply voltage of pixel units via a control circuit, and thus elevates display quality and solves the common issue of crosstalk in conventional 3D display technology.

### BRIEF DESCRIPTION OF THE DRAWINGS

FIG. 1 shows a timing diagram of signals applied in a conventional 3D display system.

FIG. 2 shows a circuit diagram of a display unit and a control circuit of a 3D display system according to a preferred embodiment of the present invention.

FIG. 3 shows a timing diagram of signals applied on the 3D system according to a preferred embodiment of the present invention.

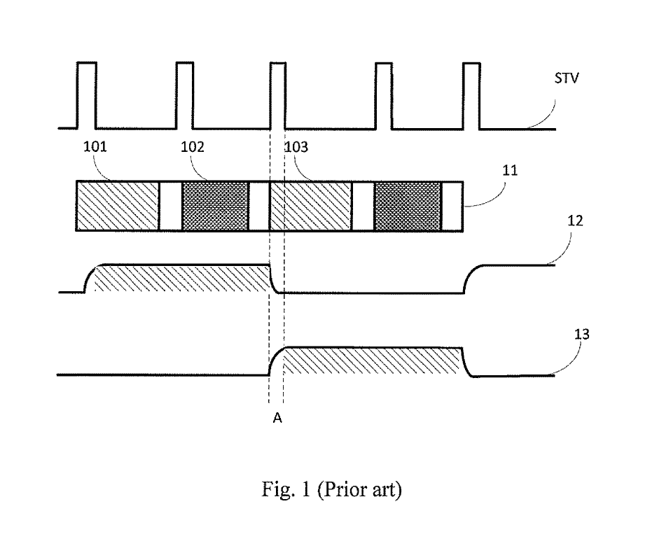

### DETAILED DESCRIPTION OF THE PREFERRED EMBODIMENTS

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures.

It is noted that the same components are labeled by the same number.

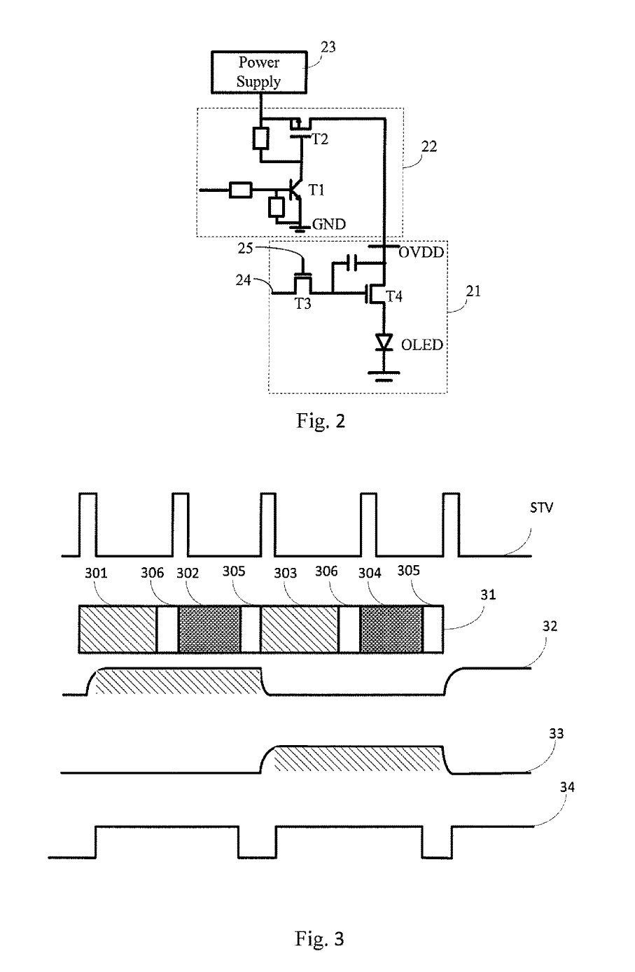

Please refer to FIG. 2, showing a circuit diagram of a display unit and a control circuit of a 3D display system according to a preferred embodiment of the present invention. The 3D display system comprises an OLED display panel and a pair of 3D shutter glasses. The OLED display panel comprises a power supply 23, a plurality of data lines (not shown), a plurality of scan lines (not shown), a plurality of pixel units 21, and a plurality of control circuits 22. The data lines are used for data signal transmission. The scan lines are used for scan signal transmission. The data lines and the scan lines surround the pixel units 21. The pixel units 21 display pixels based on signals transmitted from the data lines and the scan lines. The pixel units 21 comprise a data signal input terminal 24 connecting the data lines, a scan signal input terminal 25 connecting the scan lines, a supply voltage terminal OVDD connecting the power supply 23, and an organic light emitting diode (OLED) for pixel display. The control circuit 22 controls supply voltage of the supply voltage terminal OVDD, based on a control signal, so as to determine whether the pixel units 21 display left or right eye image. The 3D shutter glasses (not shown) comprise a left eye shutter and a right eye shutter. When the left eye shutter is fully enabled, the pixel units 21 display left eye image. When the right eye shutter is fully enabled, the pixel units 21 display right eye image.

The control circuit 22 comprises a first transistor T1 and a second transistor T2. The first transistor T1 comprises a control terminal coupled with the control signal, an input terminal coupled with a control terminal of the second transistor T2, and an output terminal grounded GND. The second transistor T2 comprises an input terminal coupled with the power supply 23 and an output terminal coupled with the supply voltage terminal OVDD of the pixel units 21. The first transistor T1 is an NPN type transistor. The second transistor T2 is a P-type metal oxide semiconductor (PMOS) transistor.

Each pixel unit 21 further comprises a third transistor T3 and a fourth transistor T4. The third transistor T3 comprises an input terminal coupled with a corresponding data line via the data signal input terminal 24, a control terminal coupled with a corresponding scan line via the scan signal input terminal 25, and an output terminal coupled with a control terminal of the fourth transistor T4. The fourth transistor T4 comprises an input terminal coupled with the supply voltage terminal OVDD, and an output terminal coupled with the OLED.

Please refer to FIG. 3, showing a timing diagram of signals applied on the 3D system according to a preferred embodiment of the present invention. The pixel units 21 displays left or right eye image according to data signal transmitted from the data lines. The left eye image further comprises a left eye data image 301 for pixel display and a left eye black image 302 for preventing crosstalk. The right eye image further comprises a right eye data image 303 for pixel display and a right eye black image 304 for preventing crosstalk. The left eye black image 302 is displayed after the display of the corresponding left eye data image 301, and before the display of the corresponding right eye data image 303. The right eye black image 304 is displayed after the display of the corresponding right eye data image 303, and before the display of the corresponding left eye data image 301.

Furthermore, a first blank interval 305 is set between the left eye image and the corresponding right eye image. More specifically, the first blank interval 305 is set between the left eye data image 301 and the right eye black image 304. Also, the first blank interval 305 is set between the left eye black image 302 and the corresponding right eye data image 303. Within the first blank interval 305, the control signal is at a low voltage level, and the power supply disconnect from the supply voltage input terminal OVDD.

And a second blank interval 306 is set between the left eye data image 301 and the corresponding left eye black image 302. Also, the second blank interval 306 is set between the right eye data image 303 and the corresponding right eye image 304. Within the second blank interval 306, the control signal is at a high voltage level, and supply voltage is fed to the supply voltage input terminal OVDD via the second transistor T2.

The setting of the left eye black image 302, the right eye black image 304, the first blank interval 305, and the second blank interval 306 are capable of preventing the crosstalk phenomenon.

When the 3D display system is working, each left eye data image 301, each left eye black image 302, each right eye data image 303, and each right eye black image 304 are all triggered enabled via an enabling signal STV.

Please refer to both FIG. 2 and FIG. 3. When the pixel units 21 start to display the left eye data image 301, a left eye shutter 32 of the 3D shutter glasses is enabled, whereas a right eye shutter 33 of the 3D shutter glasses is disabled. To prevent the left eye data image 301 from reaching a user's right eye via the right eye shutter 33, a control signal 34 of the control circuit 22 is set at a low voltage level, and the first transistor T1 is off, and supply voltage from the power supply 23 is directly fed to the control terminal of the second transistor T2. Now the second transistor T2 turned off, and the power supply 23 disconnects from the supply voltage terminal OVDD, so no supply voltage is fed to the input terminal of the fourth transistor T4, and the OLED of the pixel units 21 stops working accordingly. As a result, the crosstalk phenomenon is prevented.

When the left eye shutter 32 is fully enabled, the right eye shutter 33 is fully disabled, so the left eye data image 301 does not reach the user's right eye via the right eye shutter 33. Meanwhile, the control signal 34 of the control circuit 22 is set at a high voltage level, and the first transistor T1 is turned on, and the control terminal of the second transistor T2 grounds GND via the first transistor T1. Now the second transistor T2 is turned on, and supply voltage from the power supply 23 is fed to the supply voltage terminal OVDD via the second transistor T2, so the OLED starts to work, and the pixel units 21 display the left eye image according to data signals and scan signals.

When the pixel units 21 start to display the right eye data image 303, the right eye shutter 33 of the 3D shutter glasses is enabled, whereas the left eye shutter 32 of the 3D shutter glasses is disabled. To prevent the right eye data image 303 from reaching the user's left eye via the left eye shutter 32, the control signal 34 of the control circuit 22 is set at a low voltage level, and the first transistor T1 is turned off, and supply voltage from the power supply 23 is directly fed to the control terminal of the second transistor T2. Now the second transistor T2 turns off, and the power supply 23 disconnects from the supply voltage terminal OVDD, so no supply voltage is fed to the input terminal of the fourth transistor T4, and the OLED of the pixel units 21 stops working accordingly. As a result, the crosstalk phenomenon is prevented.

When the right eye shutter 33 is fully enabled, the left eye shutter 32 is fully disabled, so the right eye data image 303 does not reach the user's left eye via the left eye shutter 32. Meanwhile, the control signal 34 of the control circuit 22 is set at a high voltage level, and the first transistor T1 is turned on, and the control terminal of the second transistor T2 grounds GND via the first transistor T1. Now the second transistor T2 is turned on, and supply voltage from the power supply 23 is fed to the supply voltage terminal OVDD via the second transistor T2, so the OLED starts to work, and the pixel units 21 display the right eye image according to data signals and scan signals.

When the pixel units 21 start to display the left eye black image 302 or the right eye black image 304, the control signal of the control circuit 22 continues to be set at a high voltage level, so the left eye black image 302 and the right eye black image 304 do not affect the left eye data image 301 and the right eye data image 303. A higher duty cycle of the control signal 34 enhances stability of the control circuit 22.

The 3D image display process of the 3D display system of the preferred embodiment of the present invention is then done.

The present invention avoids crosstalk phenomenon by controlling supply voltage of pixel units via a control circuit, and thus elevates display quality and solves the common issue of crosstalk in conventional 3D display technology.

While the present invention has been described in connection with what is considered the most practical and preferred embodiments, it is understood that this invention is not limited to the disclosed embodiments but is intended to cover various arrangements made without departing from the scope of the broadest interpretation of the appended claims.

What is claimed is:

1. A three dimensional (3D) display system comprising:
an organic light emitting diode (OLED) display panel, comprising:
a power supply;
a plurality of data lines, for transmitting data signals;
a plurality of scan lines, for transmitting scan signals;
a plurality of pixel units, surrounded by the plurality of data lines and the plurality of scan lines, for display images according to the data signals and the scan signals, wherein each pixel unit comprises a data signal input terminal connecting one of the plurality of data lines, a scan signal input terminal connecting one of the plurality of scan lines, a supply voltage terminal connecting the power supply, and an organic light emitting diode (OLED) for pixel display, and wherein each pixel unit further comprises a third transistor and a fourth transistor, the third transistor comprises an input terminal coupled with a corresponding data line via the data signal input terminal, a control terminal coupled with a corresponding scan line via the scan signal input terminal, and an output terminal coupled with a control terminal of the fourth transistor, and the fourth transistor comprises an input terminal coupled with the supply voltage terminal, and an output terminal coupled with the OLED; and
a plurality of control circuits, for controlling a supply voltage of the supply voltage terminal, based on a control signal, to determine whether the pixel unit display left or right eye images, wherein the control circuit further comprises a first transistor and a second transistor, the first transistor comprises a control terminal coupled with the control signal, an input terminal coupled with a control terminal of the second transistor, and an output terminal grounded, the second transistor comprises an input terminal coupled with the power supply, and an output terminal coupled with the supply voltage terminal of a corresponding pixel unit; and
a 3D shutter glasses, comprising a left eye shutter and a right eye shutter, wherein when the left eye shutter is fully enabled, the pixel units display left eye image, and when the right eye shutter is fully enabled, the pixel units display right eye image.

2. The 3D display system of claim 1, wherein the first transistor is an NPN type transistor, and the second transistor is a PMOS transistor.

3. The 3D display system of claim 1, wherein when the left eye shutter is fully enabled and the control signal is set at a high voltage level, supply voltage from the power supply is fed to the supply voltage terminal via the second transistor, so the pixel unit display the left eye image;
when the right eye shutter is fully enabled and the control signal is set at a low voltage level, supply voltage from the power supply is fed to the supply voltage terminal via the second transistor, so the pixel unit display the right eye image; and
when either the left eye shutter or the right eye shutter is not fully enabled, the control signal is set at a low voltage, and the supply voltage terminal disconnect with the power supply.

4. The 3D display system of claim 1, wherein the left eye image further comprises a left eye data image for display and a left eye black image for preventing crosstalk, and the right eye image further comprises a right eye data image for display and a right eye black image for preventing crosstalk.

5. The 3D display system of claim 4, wherein the left eye black image is displayed subsequent to the left eye data image and prior to the right eye data image, and the right eye black image is displayed subsequent to the right eye data image and prior to the left eye data image.

6. The 3D display system of claim 4, wherein a first black interval is inserted between the left eye image and the right eye image, and the control signal is set at the low voltage level to disconnect the power supply and the supply voltage terminal during the first blank interval.

7. The 3D display system of claim 4, wherein a second black interval is inserted between the left eye data image and the left eye black and is inserted between the right eye data image and the left eye black, and the control signal is set at the high voltage level to connect the power supply and the supply voltage terminal via the second transistor during the second blank interval.

8. The 3D display system of claim 1, wherein the data signals are triggered by an enabling signal.

9. A three dimensional (3D) display system comprising:
an organic light emitting diode (OLED) display panel, comprising:
a power supply;
a plurality of data lines, for transmitting data signals;
a plurality of scan lines, for transmitting scan signals;
a plurality of pixel units, surrounded by the plurality of data lines and the plurality of scan lines, for display images according to the data signals and the scan signals, wherein each pixel unit comprises a data signal input terminal connecting one of the plurality of data lines, a scan signal input terminal connecting one of the plurality of scan lines, a supply voltage terminal connecting the power supply, and an organic light emitting diode (OLED) for pixel display; and
a plurality of control circuits, for controlling a supply voltage of the supply voltage terminal, based on a control signal, to determine whether the pixel unit display left or right eye images; and
a 3D shutter glasses, comprising a left eye shutter and a right eye shutter, wherein when the left eye shutter is fully enabled, the pixel units display left eye image, and when the right eye shutter is fully enabled, the pixel units display right eye image.

10. The 3D display system of claim 9, wherein the control circuit further comprises a first transistor and a second transistor, the first transistor comprises a control terminal coupled with the control signal, an input terminal coupled with a control terminal of the second transistor, and an output terminal grounded, the second transistor comprises an input terminal coupled with the power supply, and an output terminal coupled with the supply voltage terminal of a corresponding pixel unit.

11. The 3D display system of claim 10, wherein the first transistor is an NPN type transistor, and the second transistor is a PMOS transistor.

12. The 3D display system of claim 10, wherein when the left eye shutter is fully enabled and the control signal 34 is set at a high voltage level, supply voltage from the power supply is fed to the supply voltage terminal via the second transistor, so the pixel unit display the left eye image;
when the right eye shutter is fully enabled and the control signal is set at a low voltage level, supply voltage from the power supply is fed to the supply voltage terminal via the second transistor, so the pixel unit display the right eye image; and
when either the left eye shutter or the right eye shutter is not fully enabled, the control signal is set at a low voltage, and the supply voltage terminal disconnect with the power supply.

13. The 3D display system of claim 10, wherein the left eye image further comprises a left eye data image for display and a left eye black image for preventing crosstalk, and the right eye image further comprises a right eye data image for display and a right eye black image for preventing crosstalk.

14. The 3D display system of claim 13, wherein the left eye black image is displayed subsequent to the left eye data image and prior to the right eye data image, and the right eye black image is displayed subsequent to the right eye data image and prior to the left eye data image.

15. The 3D display system of claim 13, wherein a first black interval is inserted between the left eye image and the right eye image, and the control signal is set at the low voltage level to disconnect the power supply and the supply voltage terminal during the first blank interval.

16. The 3D display system of claim 13, wherein a second black interval is inserted between the left eye data image and the left eye black and is inserted between the right eye data image and the left eye black, and the control signal is set at the high voltage level to connect the power supply and the supply voltage terminal via the second transistor during the second blank interval.

17. The 3D display system of claim 9, wherein each pixel unit further comprises a third transistor and a fourth transistor, the third transistor comprises an input terminal coupled with a corresponding data line via the data signal input terminal, a control terminal coupled with a corresponding scan line via the scan signal input terminal, and an output terminal coupled with a control terminal of the fourth transistor, and the fourth transistor comprises an input terminal coupled with the supply voltage terminal, and an output terminal coupled with the OLED.

18. The 3D display system of claim 9, wherein the data signals are triggered by an enabling signal.
